(19) United States
(12) Patent Application Publication
(10) Pub. No.: US 2012/0286441 A1
(43) Pub. Date: Nov. 15, 2012

(54) Makeup Restoring Kit and Method

(76) Inventor: Pamela J. Johnson, Las Vegas, NV (US)

(21) Appl. No.: 13/106,289

(22) Filed: May 12, 2011

(51) Int. Cl. B29C 73/02; B29C 73/30

(52) U.S. Cl. 264/36.1; 425/11

(57) ABSTRACT

An economical makeup restoring kit and method that allows the individual consumer to re-solidify the fragments of a broken powder cake within the powder tray of the original compact case is provided. The makeup restoring kit includes an alcohol dispenser, a mixing/smoothing implement, and a cleaning implement. Variations of the implements are presented. The makeup restoring kit is preferably provided in a kit receptacle suitable for transporting and storing the kit contents.

### FIELD OF THE INVENTION

The present invention relates generally to re-solidification of cosmetic powder to produce a block of powder, and more particularly, to a kit and method for re-solidifying and restoring a broken pressed powder cake within the original compact case.

### BACKGROUND INFORMATION

Liquefiable powders can be solidified to form firm powder cakes or blocks, such as are commonly sold in makeup compacts as pressed powder. A powder cake packaged in a compact provides advantages for the consumer. The powder cake provides convenient spill resistance and portability; it can be easily slipped into a purse, pocket, makeup bag or suitcase. Also, opening the compact and applying the powder from the powder cake is less messy than opening and applying loose powder. Additionally, the pressed powder cakes are offered in numerous particular compositions formulated to meet the needs of consumers of varying skin types and ages, to provide light or heavy coverage, to include sunscreen, to diffuse light, to coordinate with any of a variety of foundation types, and to address other similar cosmetic demands. The compact case itself addresses other needs of the consumer; the interior may provide a beneficial mirror while the exterior look may create a fashion statement. Powder cakes offer the consumer easy containment and application of powders; merely touching a fingertip or brush to the dry, firm powder cake allows transfer of visible powder of the particular formulation to the skin. Thus, a powder cake having a specific composition contained within a stylish, useful compact case offers distinct benefits to the makeup wearer who, as a result, is often willing to pay a considerable price to obtain a pressed powder compact that meets the needs of her skin type while enhancing the finished look of her applied makeup.

However, the transportability of pressed powder compacts leads to one disadvantage. Due to the punishment incurred during the continual jostling and bumping while being carried in bags, pockets and purses, the powder cake often cracks or breaks into fragmented pieces, rendering it unusable for its intended purpose. It is wasteful and disheartening to discard the broken powder cake, particularly because of the significant initial and replacement cost. Highly desirable would be a means of re-solidifying and restoring the unusable broken pressed powder block to form a solid, uniformly hardened powder cake in the original compact.

The process used by the cosmetic industry in initially forming the powder cake is, however, well beyond that which can be accomplished in a practical manner by an individual user of the pressed powder compact. The manufacturer selects the appropriate ingredients for the particular composition formulated to meet the needs of the individual user. The selected ingredients are then blended into a mixture that is treated by methods well known in the cosmetic industry; often a wet putty is created that is then dried and compacted under specific pressures to form a firm cake. The manufacture of the powder cake requires enormous outlays for machinery able to adequately handle the huge quantities involved in such large-scale production. Thus, while using machinery utilized in the initial creation of the cake-type makeup product is not within reach of the individual consumer, the fragments of the broken powder cake still contain the appropriate ingredients, in the correct proportion, for the composition formulated to meet the particular needs of the individual user. Therefore, a consumer-friendly system and method to re-solidify the fragments into a usable cake-type makeup product in the original compact is desirable.

In an attempt to address this desire to restore the powder cake to usefulness, U.S. Pat. No. 6,358,448 to Green et al. presents a device to process the fragmented pieces of the powder cake through a processor-mounted mesh to reduce the random-sized pieces of makeup to intermediate particles of a size appropriate for agglomeration into the block of usable makeup. Then a charge of intermediate particles is placed in a compression chamber in a mold member or tray supported by the mold member holder. A ram member is movable longitudinally into the compression chamber for compressing the charge of intermediate particles passed from the mesh member into the compression chamber to agglomerate the intermediate particles of the charge into the block of usable makeup, with the block compressed into a provided mold tray. Though the Green et al. device would apparently be significantly less costly than large-scale manufacturing equipment, it nevertheless does not appear to be inexpensive with its numerous precision manufactured pieces. But importantly, while the apparatus described by Green et al. may be effective to compress fragments into a solid block in the provided mold tray, the mold tray is not designed to fit within the original compact. Thus a portion of the usefulness and cachet of the original pressed powder compact is lost.

Currently no kit or set is available that provides an individual cosmetic user with the tools and method to recover the broken fragments of a pressed powder block and to efficiently restore the unusable fragments to a solid, dry, firm powder cake. Accordingly, there is an established need for a convenient, portable, makeup restoring kit and method of use.

### SUMMARY OF THE INVENTION

The present invention is directed to a convenient makeup restoring kit and method that allows an individual consumer to easily and economically re-solidify the fragments of broken powder fragments into a usable solid block within the original compact case.

The makeup restoring kit includes an alcohol dispenser for adding alcohol to the broken fragments, a mixing/smoothing implement for blending the powder fragments with the alcohol to achieve a putty-like slurry and to smooth the top of the blended slurry, and a cleaning implement to clean the edges and/or grooves of the original compact case. Optional additions to the kit include a stamping implement, a soiled item repository, and a receptacle for conveniently transporting the makeup restoring kit.

An object of the present invention is to provide a makeup restoring kit that conveniently re-solidifies the fragments of a broken powder cake.

A further object of the present invention is to provide a makeup restoring kit that is easy for a consumer to use.

Another object of the present invention is to provide a makeup restoring kit that is space efficient for storage or transport.

An additional object of the present invention is to provide a makeup restoring kit that reduces waste by converting the unusable broken fragments into a usable form.

A further object of the present invention is to provide a makeup restoring kit that saves the consumer money compared to replacing the powder compact.

These and other objects, features and advantages of the present invention will become more readily apparent from the attached drawings and from the detailed description of the preferred embodiments, which follow.

### BRIEF DESCRIPTION OF THE DRAWINGS

The preferred embodiments of the invention will hereinafter be described in conjunction with the appended drawings, provided to illustrate and not to limit the invention, where like designations denote like implements, and in which:

FIG. 1 is a perspective view showing a broken powder cake in a compact case, presenting the problem to be addressed;

FIG. 2 is a perspective view showing a first embodiment of the makeup restoring kit of the present invention;

FIG. 3 is a perspective view showing a second embodiment of the makeup restoring kit of the present invention;

FIG. 4 is a perspective view showing a third preferred embodiment of the makeup restoring kit of the present invention;

FIG. 5 is a perspective view showing the third preferred embodiment of the makeup restoring kit of the present invention within a receptacle suitable for storage and transport;

FIG. 6 is a perspective view showing the step of gathering the broken fragments of the method of use of the makeup restoring kit of the present invention;

FIG. 7 is a perspective view showing the step of blending the alcohol dampened fragments with the mixing implement to form a putty-like slurry of the method of use of the makeup restoring kit of the present invention;

FIG. 8 is a perspective view showing the step of using a smoothing implement to smooth the top surface of the putty-like slurry of the method of use of the makeup restoring kit of the present invention;

FIG. 9 is a perspective view showing the completed restoration of the powder cake after mixing, smoothing, cleaning, imprinting and drying using the method of use of the makeup restoring kit of the present invention;

FIG. 10 is a flowchart illustrating steps in a first method of use of the makeup restoring kit of the present invention;

FIG. 11 is a flowchart illustrating steps in a second method of use of the makeup restoring kit of the present invention; and

FIG. 12 is a flowchart illustrating steps in a third method of use of the makeup restoring kit of the present invention.

Like reference numerals refer to like parts throughout the several views of the drawings.

### DETAILED DESCRIPTION OF THE PREFERRED EMBODIMENTS

Shown throughout the figures, the present invention is directed toward a makeup restoring kit and method of use for re-solidifying fragments of broken powder cake into a solid, usable block of powder. The re-solidification process is simple, practical and economical enough to be performed by the individual consumer. The implements of the kit are small and easy to store, ready for use when the need for use occurs due to breakage. The powder cake is reformed into the generally non-removable powder tray in the original decorative compact case.

The makeup restoring kit of the present invention includes a dispenser suitable for dispensing alcohol onto the broken fragments, a mixing/smoothing implement adapted to blend the fragments with the alcohol to create an alcohol-powder mixture and to smooth the top of the alcohol-powder mixture, and a cleaning implement to clean the edges of the compact case. Any combination of the kit elements are within the scope of the invention. For example, one tool may serve multiple purposes and/or multiple implements of one type may be included (such as including multiple cleaning implements to address various cleaning situations). All of the implements are sized appropriately for use with a standard compact case, as illustrated. The small size of the implements allows them to be conveniently sold, stored, transported and kept ready for use within a suitable attractive storage receptacle.

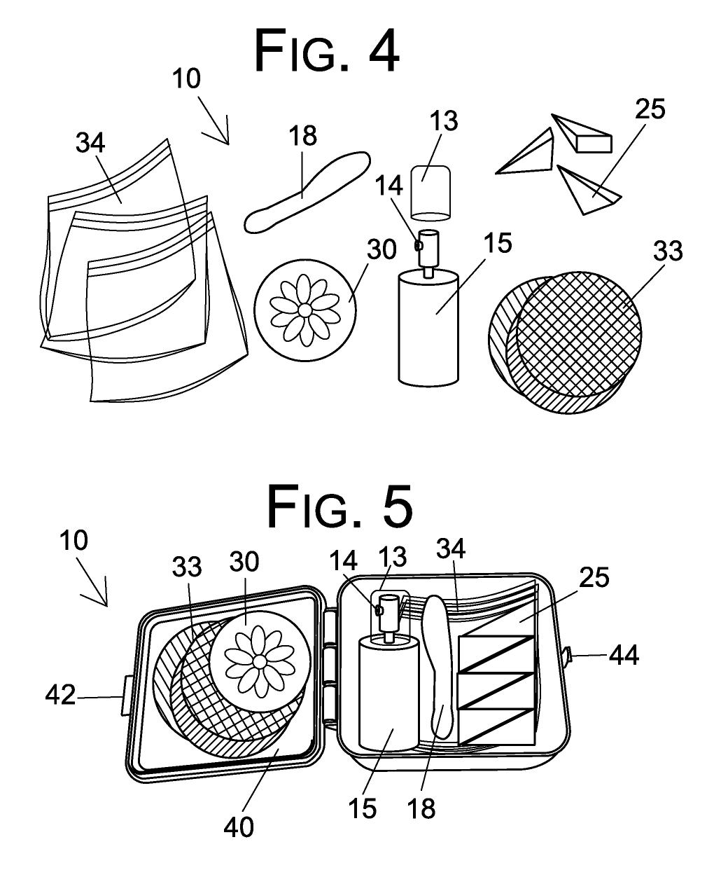

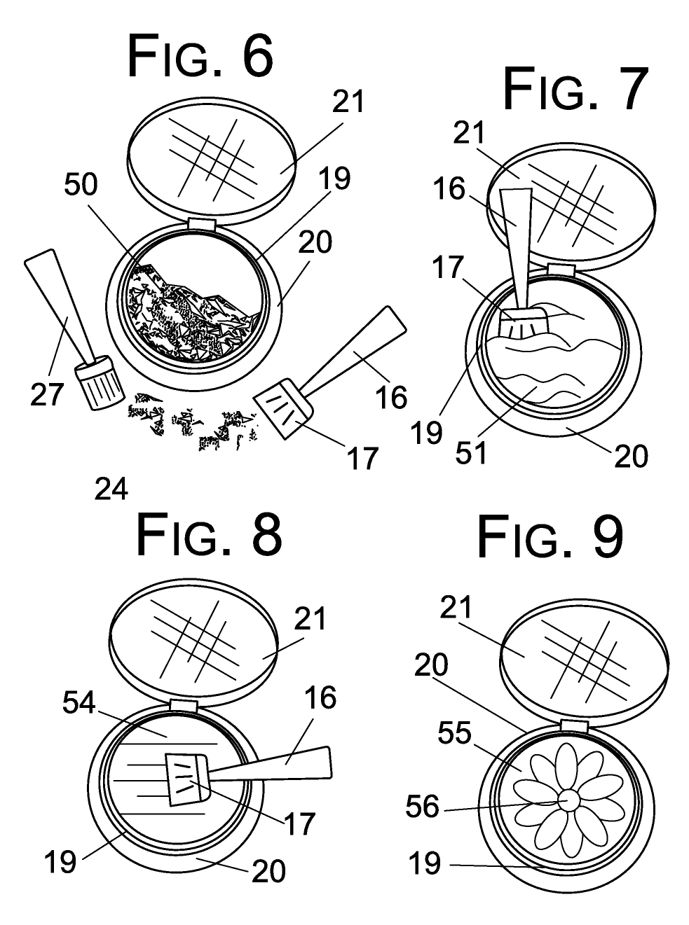

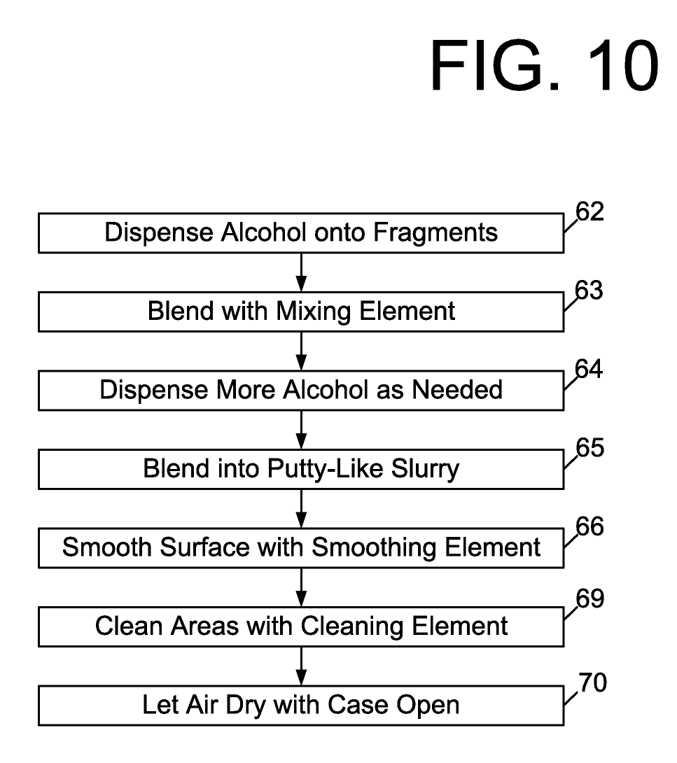

Three exemplary embodiments are presented, a first preferred embodiment (FIG. 2), a second embodiment (FIG. 3), and a third embodiment (FIGS. 4-5). Steps in the method of use of the makeup restoring kit are illustrated in FIGS. 6-9. Method steps are presented in FIGS. 10-12.

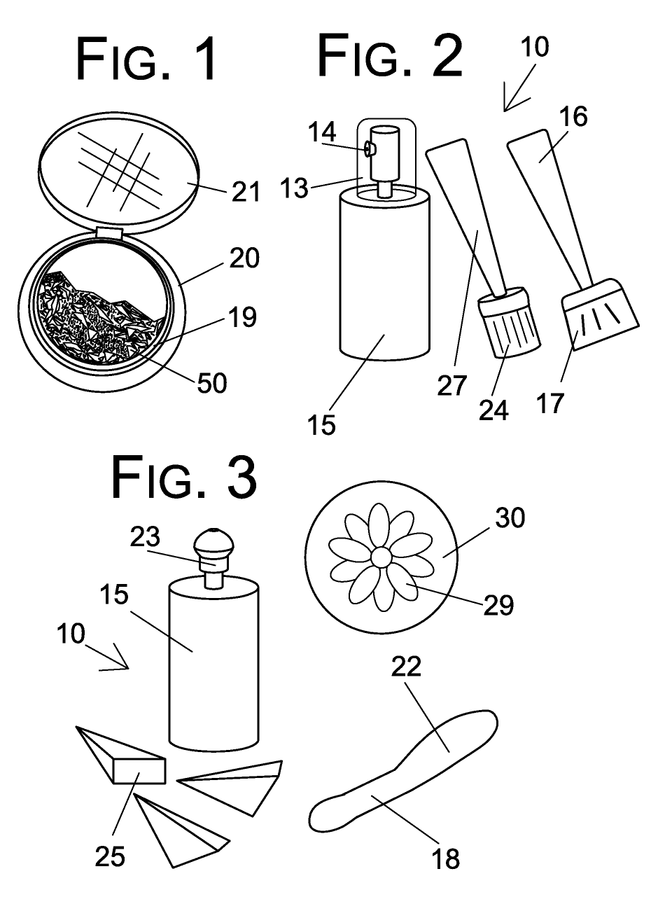

FIG. 1 presents an example of broken powder cake fragments 50 held within a powder tray 19 non-removably attached to a conventional compact case 20, such as might be encountered upon opening a compact case 20 that has been dropped or jostled.

FIG. 2 illustrates the items in a first exemplary makeup restoring kit, which include a spray-type dispenser 15 containing alcohol, a flat-bottomed scoop 16, and a brush 27. The flat-bottomed scoop 16 serves as both a mixing and smoothing implement, while the brush 27 serves as the cleaning implement.

In the first embodiment, the alcohol dispenser 15 is a spray-type dispenser, preferably formed of plastic. It is preferably provided with a lid 13 to prevent accidental dispersal during transport. The alcohol dispenser 15 is configured to securely contain at least an amount of alcohol sufficient for a single repair of a broken powder cake, and preferably an amount for two to five repairs.

The alcohol is preferably isopropyl alcohol having a concentration of between 70-100% alcohol in water. The alcohol is used to rehydrate the broken fragments 50 and form an alcohol-powder mixture or slurry within the compact powder tray. The consumer sprays the alcohol onto the fragments while mixing with the flat-bottomed scoop 16. Enough alcohol is added to the fragments and to any unbroken powder remaining in the compact tray until the mixture reaches the consistency of pudding or putty, as shown in FIG. 7. The alcohol of the alcohol-powder mixture is allowed to evaporate into the open air, reforming the solid powder cake within the powder tray of the compact case.

The scoop 16 preferably has a flat pan 17 with angled corners for reaching into the nooks and crevices at the edges of the powder tray to retrieve all of the pieces of the powder cake. The bottom of the flat pan 17 is smooth for using to level the top surface of the putty-like slurry, as shown in FIG. 8.

Preferably brush 27 has short and somewhat stiff bristles, allowing the consumer to brush the grooves around the rim of the powder tray to clean any residue left from the blending process. The scoop 16 and the handle of brush 27 may formed of plastic, metal, a natural material (such as wood or bamboo) or a combination of materials. Bristles 24 may be formed of a manmade material or of a natural fiber, such as animal hair.

FIG. 3 illustrates the items in a second exemplary kit, which include a drip-type dispenser 15 containing alcohol, a spatula 18 serving as a mixing/smoothing implement, cosmetic wedges 25 serving as the cleaning implement, and a stamp 30 serving as an imprinting implement.

The alcohol dispenser 15 of the second embodiment is configured with a conventional drip top 23 allowing the consumer to dispense the alcohol drop by drop onto the powder fragments 50 within the powder tray 19 until the appropriate consistency is reached.

The spatula 18 is shaped with a handle and a broader spreader portion 22 (FIG. 3) and is configured to allow both efficient mixing and smoothing. It may be angled to allow the user to easily access the slurry within the powder tray. It may be formed similarly to an hors d'oeuvre spreader, an appetizer knife, or the like. The spatula 18 may be unitarily formed of plastic, metal, or a natural material or formed of a combination of materials. Optionally the spreader portion 22 may be a stiff rubber attached to the handle portion of a different material.

The cosmetic wedges 25 included in the kit are the standard, disposable, triangular-shaped foam cosmetic product sold for makeup removal. A cosmetic wedge can be easily inserted into any grooves around the peripheral rim of the powder tray to remove any residual mixture.

The stamp 30 is preferably a plastic disk with a raised design 29, such as the illustrated daisy design. After smoothing the top of the alcohol-powder slurry, the raised design 29 is placed on the top surface and gently pressed to leave an impression. The stamp 30 is provided in a size that will fit within a standard powder tray to enable the design 29 to imprint the top surface.

FIG. 4 illustrates the items in a third exemplary kit with FIG. 5 illustrating the kit items contained within a storage and transport kit receptacle 40. The kit of the third embodiment includes the spray-type dispenser 15 containing alcohol, the spatula 18 serving as the mixing/smoothing implement, cosmetic wedges 25 serving as the cleaning implement, a soiled item repository 34, two imprinting implements (stamp 30 and textured absorbent paper disks 33), and kit receptacle 40.

The paper disks 33 are formed of absorbent paper similar to thick paper towel material or filter paper; the absorbent paper includes an integral texture, word, logo, graphic design or the like. Paper disks 33 are usable to imprint a texture onto the top surface of the repaired powder cake. When placed on the top surface, the paper disk 33 may also serve to absorb a portion of the alcohol from the alcohol-powder mixture, thus decreasing drying time. As the paper disks 33 are disposable, preferably multiple disks 33 are included within the kit for multiple repairs. The textured absorbent paper disks 33 may be provided in a size sufficient to extend over the edges of a conventional powder tray, as a close fit is not necessary due to the flexibility of the paper.

The soiled item repository 34 is configured to receive any implement that may be soiled, and to hold the soiled implement until such a time as the implement may be discarded (such as the disposable cosmetic wedges) or may be cleaned for reuse. The inclusion of soiled item repository 34 keeps the inside of the receptacle 40 clean and minimizes cleanup. To minimize costs, the soiled item repository 34 may be a disposable plastic bag with a press closure. To minimize waste, the soiled item repository 34 may be a zippered fabric bag with a leak-proof interior coating, a small hard plastic case sized to receive the soiled implements, or a similar small container to preserve the tidiness of the kit.

The kit receptacle 40 may be any container, holder, canister, case or box that is suitable for receiving small implements and for carrying in a purse, bag or suitcase. Preferably the kit receptacle 40 is configured with a fastening mechanism (shown as complementary fastener components 42, 44 in FIG. 5) that holds the kit receptacle in the closed position during transport, yet allows easy access by the consumer to the contents without the use of a tool or key. The kit receptacle 40 may be hard-side or a soft-side case. Preferably, receptacle 40 will include an aesthetically pleasing exterior to enhance the marketability of the kit and the user's enjoyment of the product.

The makeup restoring kit 10 may contain any combination of the above presented implements, including multiples of the same type. For instance, to give the consumer tools to address each instance of needed repair, both the spatula 18 of FIG. 4 and the scoop 16 may be included as mixing/smoothing tools and/or both the cosmetic wedge 25 and the brush 24 may be included as cleaning tools, etc.

FIGS. 6 to 9 show steps in the method of using the makeup restoring kit 10 of the present invention, as described in the flowcharts of FIGS. 10 to 12.

Turning to FIG. 10, to use the makeup restoring kit of the present invention, alcohol is dispensed 62 from the alcohol dispenser, either by dripping from the drip top 23 (FIG. 3) or, preferably, by spraying using the spray top 14 (FIG. 2), onto the fragments in the powder tray 19 of the compact case 20. The mixing implement (scoop 16, FIG. 2 or spatula 18, FIG. 3) is used to manually blend 63 the alcohol with the fragments and any unbroken segments of the original powder cake, as illustrated in FIG. 7.

The consumer may dispense 64 more alcohol, as needed to wet the powder to the consistency of pudding or putty forming an alcohol-powder mixture or slurry. The mixing implement is used to blend 65 the slurry. When all of the fragments and any unbroken segments are incorporated into the slurry, the consumer uses the mixing/smoothing implement to smooth 66 the top surface of the slurry to achieve a neat appearance.

The consumer may use a cleaning implement (brush 27, FIG. 2, or cosmetic wedges 25, FIG. 3) to clean 69 any spilled slurry and any residual powder from the compact case 20 and around the rim of the powder tray 19. The slurry is then allowed to dry with the lid 21 (FIG. 1) of the compact case remaining open to allow the alcohol to evaporate. After the alcohol has evaporated, the reformation of a solid block of powder in the tray is complete and can be used for application to the skin.

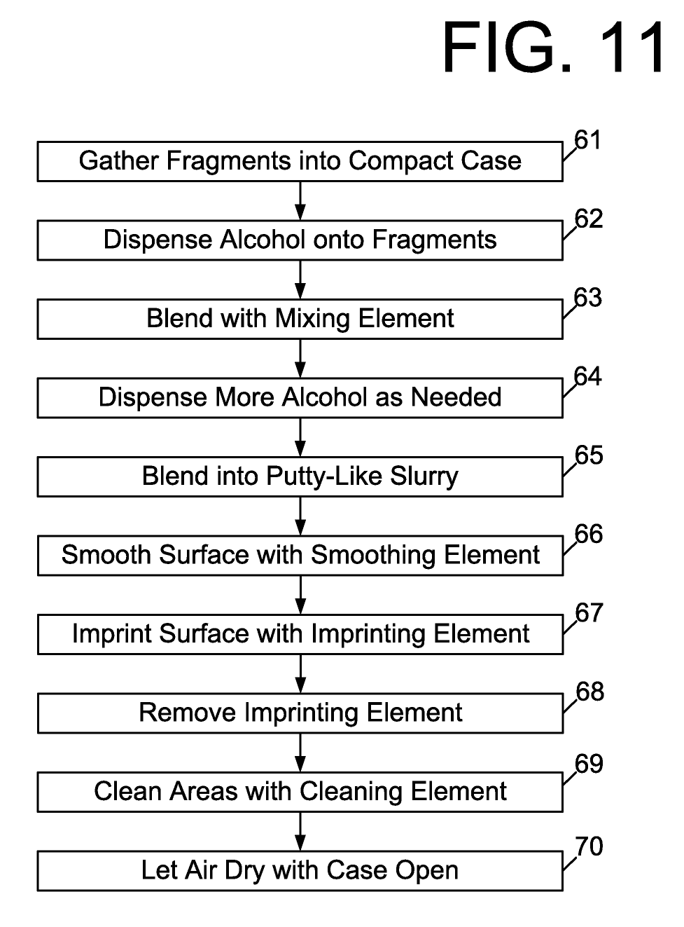

A second method of use is illustrated in FIG. 11, which includes the steps of FIG. 10 plus additional method steps that include imprinting a design while reforming the powder cake.

As the consumer does not know in advance that the powder cake has broken, it is easy to spill a portion of the powder fragments 50 when opening the compact case. Therefore, the fragments 50 may need to be gathered 61 into the powder case before the re-solidifying process begins, as shown in FIG. 6. Brush 27 may be used to push the fragments 50 onto scoop 16 with the scoop 16 used to place the spilled fragments 50 into the powder tray 19.

Also, as shown in FIG. 9, the consumer may desire to imprint an aesthetically pleasing design 56 onto the top surface of the restored powder. The stamp 30 with the raised design 29 is placed onto the top of the slurry and gently imprinted 67. The stamp 30 is removed 68 and the slurry within the compact tray is allowed 70 to dry. As shown in FIG. 9, the finished restoration will retain the imprinted image 56.

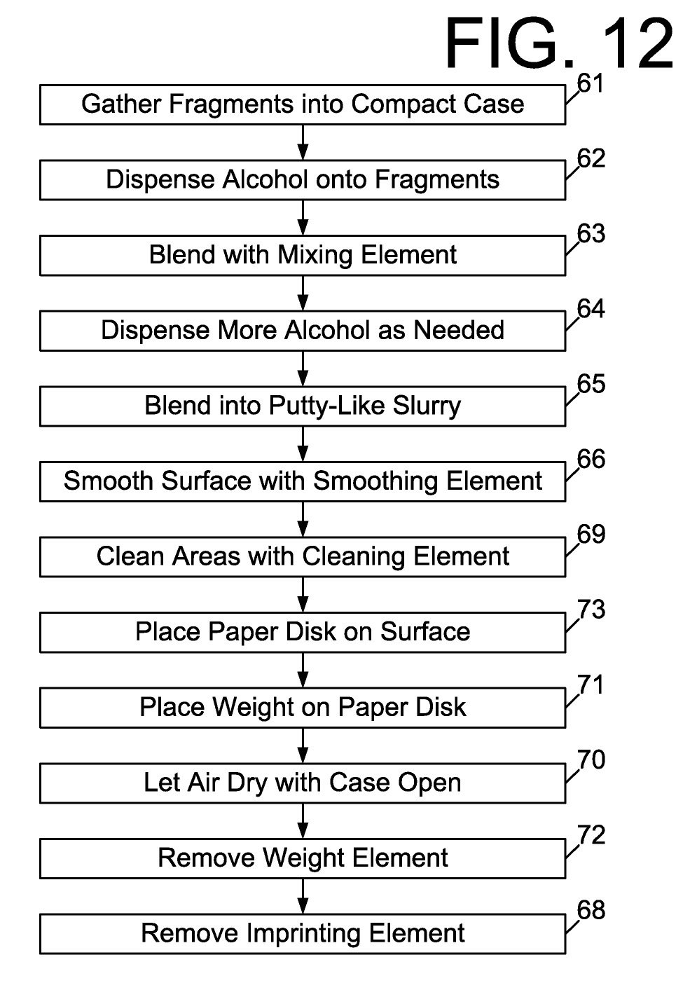

FIG. 12 illustrates a method of using the makeup restoring kit with another imprinting implement using the textured absorbent paper disks 33 and with the use of an available weight. After the surface of the slurry is smoothed 66, the absorbent paper disk 33 is placed 73 onto the top surface. A weight (an available household weight or a weight, not shown, optionally included within the kit) is placed 71 onto the absorbent paper disk 33. A household item with a flat bottom may be used for the weight, such as a small can of food or a bottle of lotion. The weight used should be sufficiently heavy to hold the paper disk 33 firmly in place, but not so heavy as to cause the slurry to be forced out of the tray 19. The compact case is left open and the alcohol-powder slurry is allowed 70 to air dry, allowing the alcohol to evaporate. After the alcohol has evaporated, the weight is removed 72. Then, the paper disk 33 is removed, leaving a texture or design imprinted on the solid powder cake. The restoration of the makeup is completed, and the makeup is now ready to use.

From the foregoing, it will be apparent that the makeup restoring kit 10 of the current invention provides a convenient, space efficient, easy-to-use kit that conveniently re-solidifies the fragments of a broken powder cake, reducing waste and saving money by reforming a usable powder cake.

Since many modifications, variations and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. A method for repairing a broken powder cake, comprising:
adding alcohol from an alcohol dispenser to the powder fragments in a powder tray of a compact case in an amount sufficient to achieve a putty-like alcohol-powder slurry;
mixing the alcohol-powder slurry with a mixing/smoothing implement;
cleaning the edges of the compact case with a cleaning implement;
smoothing the top surface of the alcohol-powder slurry with a smoothing implement; and
allowing the alcohol from the alcohol-powder slurry within the powder tray to evaporate.

2. The method for repairing a broken powder cake as recited in claim 1, further comprising imprinting the top of the alcohol-powder slurry with a design.

3. The method for repairing a broken powder cake as recited in claim 2, wherein imprinting the top of the alcohol-powder slurry with a design comprises placing a stamp with a raised design onto the top surface of the alcohol-powder slurry to leave an imprint of the raised design.

4. The method for repairing a broken powder cake as recited in claim 2, wherein imprinting the top of the alcohol-powder slurry with a design comprises placing an absorbent textured paper disk on the top surface of the alcohol-powder slurry to leave an imprint of the texture.

5. The method for repairing a broken powder cake as recited in claim 4, further comprising:
placing a weight configured to fit within the powder tray upon the absorbent textured paper disk on the top surface of the alcohol-powder slurry; and
allowing the weight to remain upon the absorbent textured paper disk until a substantial portion of the alcohol evaporates from the alcohol-powder slurry.

6. The method for repairing a broken powder cake as recited in claim 1, wherein adding alcohol from an alcohol dispenser to the powder fragments comprises spraying alcohol from a spray-type alcohol dispenser onto the powder fragments.

7. The method for repairing a broken powder cake as recited in claim 1, wherein adding alcohol from an alcohol dispenser to the powder fragments comprises dripping alcohol from a drip-type alcohol dispenser onto the powder fragments.

8. The method for repairing a broken powder cake as recited in claim 1, further comprising gathering the broken powder fragments of powder cake into the powder tray of the compact case.

9. A kit for re-solidifying fragments of powder cake into the powder tray of a compact case, comprising:
an alcohol dispenser operable to dispense alcohol onto the powder cake fragments in a sufficient amount to achieve a putty-like alcohol-powder slurry;
a mixing/smoothing implement configured to mix the dispensed alcohol with the pressed powder fragments and configured to smooth the top surface of the alcohol-powder slurry; and
a cleaning implement configured to clean areas of the compact case exterior to the powder tray.

10. The kit for re-solidifying fragments of powder cake into the powder tray of a compact case as recited in claim 9, wherein the cleaning implement comprises a sponge-type cosmetic wedge.

11. The kit for re-solidifying fragments of powder cake into the powder tray of a compact case as recited in claim 9, wherein the cleaning implement comprises a small brush.

12. The kit for re-solidifying fragments of powder cake into the powder tray of a compact case as recited in claim 9, wherein the mixing/smoothing implement comprises a flat-bottomed scoop.

13. The kit for re-solidifying fragments of powder cake into the powder tray of a compact case as recited in claim 9, wherein the mixing/smoothing implement comprises a spatula.

14. The kit for re-solidifying fragments of powder cake into the powder tray of a compact case as recited in claim 9, wherein the smoothing implement comprises a plastic disk incorporating a raised image suitable for stamping the top surface of the alcohol-powder slurry.

15. The kit for re-solidifying fragments of powder cake into the powder tray of a compact case as recited in claim 9, further comprising a stamp incorporating a raised image suitable for imprinting the top surface of the alcohol-powder slurry.

16. The kit for re-solidifying fragments of powder cake into the powder tray of a compact case as recited in claim 9, further comprising a soiled item repository configured to receive at least one of the following items: the mixing/smoothing implement and the cleaning implement.

17. The kit for re-solidifying fragments of powder cake into the powder tray of a compact case as recited in claim 9, further comprising a kit receptacle configured to receive the mixing/smoothing implement, the cleaning implement, and the alcohol dispenser.

18. The kit for re-solidifying fragments of powder cake into the powder tray of a compact case as recited in claim 17, wherein the kit receptacle comprises a top portion, a bottom portion, and a fastening mechanism adapted to fasten the top portion to the bottom portion.

19. The kit for re-solidifying fragments of powder cake into the powder tray of a compact case as recited in claim 18, wherein the fastening mechanism is configured for retaining the receptacle in the closed position during transport and for allowing keyless access to the interior of the case.
